(19) United States
(12) Patent Application Publication
(10) Pub. No.: US 2019/0334325 A1
(43) Pub. Date: Oct. 31, 2019

(54) Offshore Structure

(71) Applicant: SIEMENS AKTIENGESELLSCHAFT, München (DE)

(72) Inventor: JOERG FINDEISEN, DRESDEN (DE)

(21) Appl. No.: 16/070,798

(22) PCT Filed: Dec. 21, 2016
(86) PCT No.: PCT/EP2016/082058

§ 371 Date: Jul. 18, 2018

(30) Foreign Application Priority Data
Jan. 21, 2016 (DE) 10 2016 200 800.5

(51) Int. Cl. H02B 7/06; F03D 13/25; F03D 9/00; H02B 1/46; H02B 1/56; H02B 1/28

(52) U.S. Cl. CPC H02B 7/06; F03D 13/25; F03D 9/00; F03D 9/30; H02B 1/56; H02B 1/28; H02B 1/46

(57) ABSTRACT

An offshore structure includes an electrical device with a housing filled with an insulating liquid, and it includes an expansion vessel system, the inner volume of which has a region containing insulating liquid as well as a gas cushion. The housing, a pipe and the expansion vessel system form a pressure-tight, hermetically sealed unit. The offshore structure is particularly easy to build due to the fact that the gas cushion is at least in part arranged below sea level.

The invention relates to an offshore structure having an electrical device which comprises a housing which is filled with an insulating liquid, further comprising an expansion vessel system whose inner volume comprises a gas cushion, wherein the housing is connected to the expansion vessel system via a pipeline, wherein housing, pipeline and expansion vessel system form a pressure-tight, hermetically sealed unit.

“Offshore structures” refers to fixed structures which have been erected offshore in open-sea location. These include for example drilling rigs, wind power installations and transformer and research platforms.

In this case, specific foundation structures are necessary for the safe erection of offshore structures. These may for example be anchored in the seabed. With drilling rigs already tested over a relatively long period of time, there are in this case framework constructions which are placed on the seabed (jackets). Recent developments either likewise focus on constructions which stand on the seabed (tripods, heavyweight foundations, bucket foundations) or use the load-bearing capacity of piles which are rammed into the seabed (monopiles, tripile foundations). Alternatively, the foundation structure may also be of floating form, that is to say formed as a so-called floating foundation with buoyancy bodies which, for maintenance of position, are fastened to the seabed solely by way of anchors on chains or the like.

In particular in wind farms, even at sea, there is a need for electrical devices which are designed for high power and are embedded in a cooling or insulating liquid, for example transformers or throttles. Here, the device generally comprises a housing which surrounds the electrical components and which is filled with the insulating liquid, for example oil. Such sealed housings require in this case an expansion vessel system for compensating for the variations in volume of the cooling and insulating liquid resulting from different operating temperatures. In the case of transformers, for example, said expansion vessel is normally arranged on the cover of the transformer.

In offshore structures this placement has an unfavorable effect, however, since it firstly provides a large surface for the wind to act on at sea, this necessitating a design for extreme weather conditions, that is to say wind speeds of more than 200 km/h. Secondly, complex brackets are required for fastening and for maintenance work. Thirdly, with the thermally induced variations in volume of the insulating liquid in the expansion vessel, this brings about the necessity of dehumidification measures for the exchange of air.

For the at least partial solution of these problems, the hermetic sealing of such electrical devices with the inclusion of a gas cushion has been proposed, said cushion accommodating the variations in volume of the cooling and insulating fluid. The expansion vessel system is in this case of closed form and its inner volume includes a gas cushion. The housing of the electrical device is connected to the expansion vessel system via a pipeline.

In this case, however, the variations in the outer temperature bring about considerable temperature-dependent variations in pressure inside the electrical installation owing to the high expansion coefficients of the gases, which have to be limited by way of complex measures.

It is therefore the object of the invention to specify an offshore structure of the type mentioned in the introduction, which allows a particularly simple construction.

Said object is achieved according to the invention in that at least part of the gas cushion is arranged below the sea level.

The invention proceeds in this case from the consideration that the variations in pressure inside the closed expansion tank system could be reduced in that a temperature which is as constant as possible is achieved in particular in the gas cushion inside the expansion tank system. Thus, the gas cushion would have to be conditioned. However, in offshore applications, the surrounding seawater is suitable in particular for this purpose, and so particularly simple conditioning of the expansion vessel system and, in particular, of the gas cushion is possible by spatially separating the expansion vessel system from the transformer and placing at least the gas cushion below the sea level. Here, the placement is realized such that a sufficient exchange of heat between the gas cushion and the seawater is possible. This results in a substantial coupling of the temperature of the gas to the temperature of the seawater surrounding the foundation structure. For example, a gas-filled expansion tank may be fastened to the outer wall of the foundation structure of the offshore structure below the sea level.

Advantageously, the entire expansion vessel system is arranged below the sea level, that is to say the pipeline is routed from the housing, which is filled with cooling and insulating liquid, into a region below the sea level where the component(s) of the expansion vessel system are arranged.

In one first advantageous configuration, the expansion vessel system comprises an expansion vessel containing a region with insulating liquid, wherein the pipeline is filled with liquid and is connected to the region with insulating liquid in the expansion vessel, and further comprises a compression chamber which is connected via a gas-filled pipeline to that part of the gas cushion which is contained in the expansion vessel, wherein the compression chamber is arranged below the sea level. In such an embodiment of the expansion vessel system, which is at least a two-part embodiment, it is possible for the entire liquid region to still be arranged above the sea level, there merely being part of the gas cushion arranged at least partially below the sea level in a separate compression chamber by means of corresponding pipelines.

With rising temperature, the insulating liquid expands and displaces the gas into the compression chamber of the expansion vessel system through the pipeline. Since the largest part of the gas is then situated inside the compression chamber and the latter scarcely has variations in temperature owing to the thermal coupling to the water temperature, the volume expansion coefficient of the gas can be effective only to a small extent and has only a small influence on the inner pressure of the transformer and the expansion vessel system thereof.

In a further advantageous configuration, the offshore structure comprises at least one second electrical device which comprises a second housing which is filled with an insulating liquid, wherein the expansion vessel system comprises a second expansion vessel, wherein the second housing is connected via a second liquid-filled pipeline to a second expansion vessel in the expansion vessel system, which vessel contains a second region with insulating liquid, wherein that part of the gas cushion which is contained in the second expansion vessel is connected to the compression chamber via a second gas-filled pipeline. In other words, the expansion vessels of multiple electrical devices are interconnected and use a common compression volume.

In a second, alternative advantageous development of the offshore structure, the pipeline is filled with gas. In such an embodiment, the housing of the electrical device itself already comprises part of the gas cushion, which is connected to the space in the expansion vessel system via the pipeline. In this case, the expansion vessel system is exclusively filled with gas.

In such an embodiment too, it is possible for multiple electrical devices to use a common expansion vessel system. For this purpose, the offshore structure advantageously comprises a second electrical device which comprises a second housing which is filled with an insulating liquid, wherein the second housing is connected to the expansion vessel system via a gas-filled pipeline.

In this case, a plurality of interconnected expansion vessels and/or compression chambers are advantageously provided. This allows a more flexible arrangement even at different positions below the sea level, and the use of the expansion vessel system for multiple electrical devices. Furthermore, this simplifies adaptation to existing geometries of the foundation structure, for example in the case of the pipes of a framework construction being used.

In one particularly advantageous configuration, that part of the gas cushion which is arranged below the sea level, that is to say in particular an expansion vessel and/or compression chambers, is arranged in a hollow structural element of the foundation structure of the offshore structure. This allows a particularly simple and space-saving design.

Here, the hollow structural element advantageously at least partially forms a wall enclosing the gas cushion, that is to say a wall of the hollow structural element is at the same time a wall of the compression chamber. In an extreme case, it is even possible for the hollow structural element to form the compression chamber in its entirety.

If this is not the case, and a space remains between the compression chamber and the hollow structural element, said space is advantageously filled with water to ensure good heat exchange.

In a further advantageous configuration, an expansion vessel comprises a diaphragm which separates gas cushion and insulating liquid from one another. Such an elastic diaphragm substantially avoids the situation in which the gas in the expansion vessel system dissolves in the cooling and insulating liquid.

Furthermore, the liquid-filled pipeline between the housing and the expansion vessel system advantageously has a Buchholz relay. In contrast to an embodiment with expansion radiators, in the embodiment proposed here, it is indeed actually possible to use a Buchholz relay in the first place. The latter indicates faults such as short circuits, inter-winding shorts or also a shortage of cooling and insulating liquid and thus increases the level of operational safety.

Advantageously, the electrical device is a transformer, for example at a substation of a wind farm. Precisely transformers for offshore wind farms are often designed to be filled with oil, and so the embodiment described offers particularly great advantages here.

The offshore structure furthermore advantageously comprises a wind power installation.

The advantages obtained by way of the invention are in particular that, owing to the gas cushion of a hermetically sealed expansion vessel system being arranged at least partially below the sea level, heat exchange between seawater and gas, and thus evening out of the temperature of the gas, is achieved. Consequently, variations in pressure inside the electrical device (for example a transformer) are reduced. A drastic reduction in the size of the compensation vessels, hitherto of rather large volume, can be achieved.

The solution described thus offers a simplified possibility for sealing with respect to oxygen and moisture (hermetic sealing) of the fluid-filled components of an offshore substation. The solution lends itself in particular to the case in which alternative insulating liquids are used. Furthermore, owing to dehumidification measures no longer being necessary, freedom from maintenance is substantially achieved.

The solution described furthermore allows a reduction in the total height of the transformer to be achieved. A particularly small structural height is desirable since the proximity to the circle of rotation of the rotor blade of a wind power installation limits the structural height of the transformer at a wind power installation having its own substation. The use of the proposed solution would significantly promote the use of conventional foundation structures. Even when the transformer is enclosed, advantages are obtained from the reduction in the structural height of the cell by approximately 2-3 m.

Exemplary embodiments of the invention will be discussed in more detail on the basis of drawings, in which:

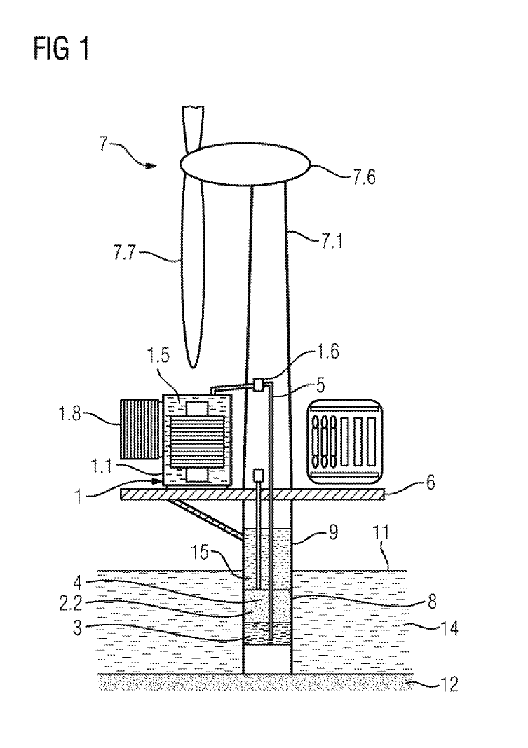

FIG. 1 shows an offshore wind power installation having a transformer with an expansion vessel in the foundation structure,

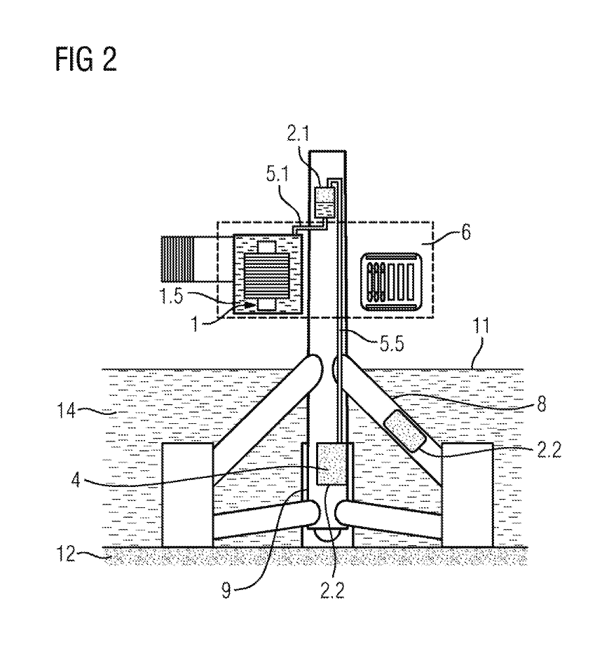

FIG. 2 shows an offshore substation having a transformer and compression chambers in the foundation structure,

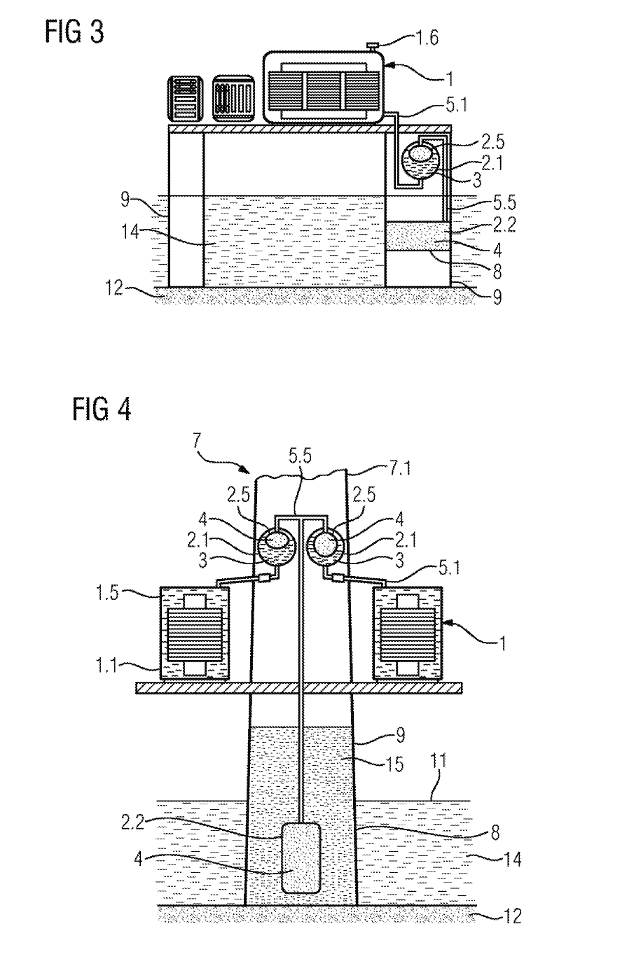

FIG. 3 shows a further offshore substation having a transformer and compression chambers in the foundation structure,

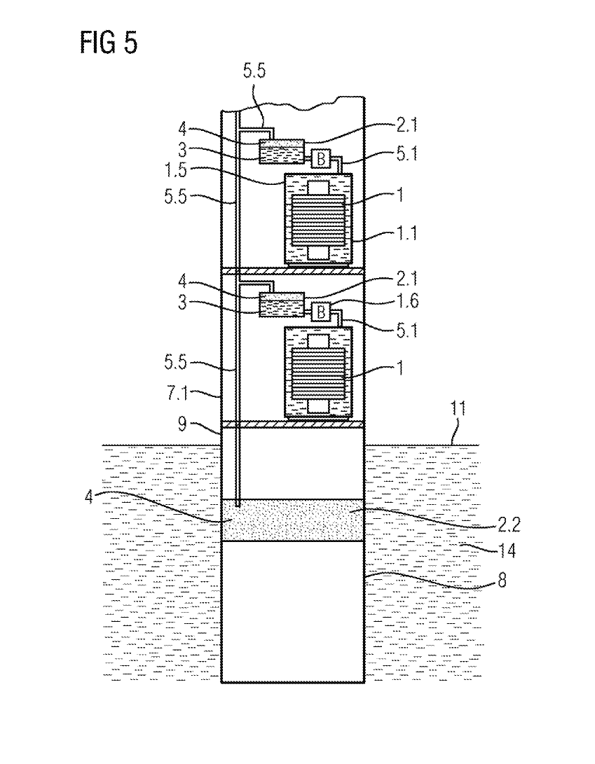

FIG. 4 shows an offshore wind power installation having two transformers, each with one expansion vessel, and a compression chamber in the foundation structure,

FIG. 5 shows a further offshore wind power installation having two transformers, each with one expansion vessel, and a compression chamber in the foundation structure, and

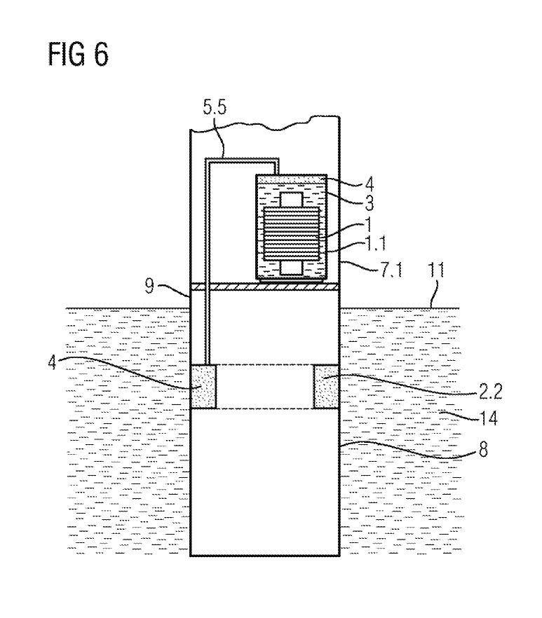

FIG. 6 shows a further offshore wind power installation having a transformer, with an incorporated expansion space, and a compression chamber in the foundation structure.

Identical parts are provided with the same reference signs in all the drawings.

FIG. 1 shows an exemplary embodiment for a substation 6, arranged on the foundation structure 9 of an offshore wind power installation 7, for an offshore wind farm. The substation 6 has a transformer 1 with a hermetically sealed housing 1.1 which is filled with an insulating liquid 1.5, and further has a cooling system 1.8. The foundation structure 9 fixes the wind power installation 7, with its tower 7.1, the nacelle 7.6 and the rotor 7.7 fastened thereon, in the seabed 12.

The thermally induced variations in volume of the insulating liquid 1.5 result in the flow of the latter into a compression chamber 2.2, which is embedded in a hollow structural element 8 of the foundation structure 9, via a pipeline 5 which is equipped with a Buchholz relay 1.6. The compression chamber 2.2 is dimensioned such that, above the changing level of the insulating liquid 3, space is formed for a gas cushion 4 which accommodates the variations in volume of the fluid. The pipeline 5 to the compression chamber 2.2 leads to the bottom thereof, and so, independent of the fill level, it is ensured that the connecting line to the transformer is filled with insulating liquid 1.5, 3 at all times.

The compression chamber 2.2 is arranged in a hollow structural element 8 of the foundation structure such that it is substantially situated below the sea level 11. The hollow structural element 8 is filled with fresh water 15. The gas cushion 4 then substantially absorbs the temperature of the surrounding seawater 14. For example, in large parts of the North Sea, the water temperature varies only between 4° C. and 18° C. It is thus possible for the hermetically sealed transformer 1 to work with a drastically reduced pressure range. The compression chambers can be reduced in size significantly.

FIG. 2 shows an offshore substation 6 which is arranged on a platform whose foundation structure 9 is formed from a multi-part pipe structure. In the exemplary embodiment in FIG. 2, the expansion vessel system is formed by multiple separated expansion vessels 2.1, 2.2. The expansion vessel 2.1 is connected via a pipeline 5.5 to further compression chambers 2.2 for the gas cushion 4, which chambers are arranged such that the gas cushion 4 is thermally decoupled from the temperature of the insulating liquid 1.5 in the transformer 1. In the exemplary embodiment, both the expansion vessel 2.1 and the compression chambers 2.2 which are thermally decoupled from the transformer 1 are formed by sheet-metal cylinders.

FIG. 3 shows an offshore substation 6 which is situated on a platform. Said platform is anchored in the seabed 12 via pipe-shaped hollow structural elements 8. In the exemplary embodiment, use is made of said hollow structural elements 8 for accommodating the expansion vessel system formed from an expansion vessel 2.1 and a compression chamber 2.2. In the exemplary embodiment, a segment of the foundation structure 9 forms the compression chamber 2.2. The casing surface of the hollow structural element 8 forms a part of the housing of the compression chamber 2.2. In this specific exemplary embodiment, the gas cushion 4 is separated from the insulating liquid 3 by a diaphragm 2.5 which is arranged inside the expansion vessel 2.1 for the insulating liquid 3. As a result of this separation, the dissolving of the gas of the gas cushion 4 in the insulating liquid 3 is substantially avoided.

FIG. 4 finally shows an exemplary embodiment in which an offshore substation 6 is integrated in the hollow structure which accommodates the tower 7.1 of a wind power installation 7. In the exemplary embodiment, the substation 6 has multiple fluid-filled components (transformers 1 and throttles) which each have their own expansion vessel 2.1 for the insulating liquid 3. The expansion vessels 2.1 are each connected on the gas side to a common compression chamber 2.2 via pipelines 5.5. In order to accommodate the compression gas 4, multiple transformers 1 accordingly use a common compression chamber 2.2 below the sea level 11, with the separation of the insulating liquids 1.5, 3 being maintained.

The use of a common compression volume allows a reduction in the total volume to be realized since not all the components have the same operating temperature. Furthermore, in this way, part of the installations may operate in overload mode without a corresponding dimensioning of the individual compression chambers being necessary.

FIG. 5 likewise shows an exemplary embodiment in which multiple transformers 1 are arranged in the tower 7.1 or the foundation structure 9 of a wind power installation 7. The transformers 1 each have their own expansion vessel 2.1. The expansion vessels 2.1 are connected via pipelines 5.5 to a compression chamber 2.2 which is used jointly by multiple transformers 1.

Furthermore, in the exemplary embodiment, both the transformers 1 and the expansion vessel system with the compression chamber 2.2 are arranged inside the foundation structure 9 or the tower 7.1 of a wind power installation 7. The cooling of the transformer 1 may be realized both via oil-water coolers and air coolers or radiators and is not represented in the exemplary embodiment.

In the exemplary embodiment, the wall of the foundation structure 9 at least partially represents the housing of the expansion vessel system or of the compression chamber 2.2.

FIG. 6 shows an exemplary embodiment in which the expansion space for accommodating the temperature-induced variations in volume of the insulating liquid 1.5 is arranged inside the transformer housing 1.1. The space not taken up by the insulating liquid, and the pipeline 5.5 and the compression chamber 2.2 of the expansion vessel system are filled with a gas cushion 4. With rising temperature, the insulating liquid 1.5, 3 expands and displaces the gas into the compression chamber 2.2 of the expansion vessel system through the pipeline 5.5. Since the largest part of the gas is then situated inside the compression chamber 2.2 and the latter scarcely has variations in temperature due to the thermal coupling to the water temperature, the volume expansion coefficient of the gas can be effective only to a small extent and has only a small influence on the inner pressure of the transformer 1 and the expansion vessel system thereof.

No fixing of the foundation structure 9 to the seabed 12 is shown in FIGS. 5 and 6 since the foundation structure 9 may also be designed as a floating foundation.

### LIST OF REFERENCE SIGNS

1 Transformer
1.1 Housing
1.5 Insulating liquid
1.6 Buchholz relay
1.8 Cooling system
2.1 Expansion vessel
2.2 Compression chamber
2.5 Diaphragm
3 Insulating liquid
4 Gas cushion
5, 5.1,
5.5 Pipeline
6 Offshore substation
7 Wind power installation
7.1 Tower
7.6 Nacelle
7.7 Rotor
8 Hollow structural element
9 Foundation structure
11 Sea level
12 Seabed
14 Seawater
15 Fresh water

1-14. (canceled)

15. An offshore structure, comprising:
an electrical device having a housing filled with an insulating liquid;
an expansion vessel system with an inner volume forming a gas cushion, wherein at least a part of said gas cushion is arranged below sea level; and
a pipeline disposed to connect said housing to said expansion vessel system, wherein said housing, said pipeline and said expansion vessel system are connected to form a pressure-tight, hermetically sealed unit.

16. The offshore structure according to claim 15, wherein an entire said expansion vessel system is arranged below the sea level.

17. The offshore structure according to claim 15, wherein said expansion vessel system comprises:
an expansion vessel containing a region with insulating liquid, wherein the pipeline is filled with liquid and is connected to said region with the insulating liquid in said expansion vessel;
a compression chamber connected via a gas-filled pipeline to the part of the gas cushion that is contained in said expansion vessel, wherein said compression chamber is arranged below the sea level.

18. The offshore structure according to claim 17, further comprising at least one second electrical device having a second housing filled with an insulating liquid, and wherein:
said expansion vessel system comprises a second expansion vessel;
said second housing is connected via a second liquid-filled pipeline to said second expansion vessel, which contains a second region with insulating liquid; and
the part of the gas cushion that is contained in said second expansion vessel is connected to said compression chamber via a second gas-filled pipeline.

19. The offshore structure according to claim 15, wherein said pipeline is filled with gas.

20. The offshore structure according to claim 19, further comprising at least one second electrical device having a second housing filled with an insulating liquid and a gas-filled pipeline connecting said second housing to said expansion vessel system.

21. The offshore structure according to claim 15, wherein said expansion vessel system comprises a plurality of interconnected expansion vessels and/or compression chambers.

22. The offshore structure according to claim 15, wherein that part of the gas cushion that is arranged below the sea level is formed in a hollow structural element of a foundation structure of the offshore structure.

23. The offshore structure according to claim 22, wherein said hollow structural element at least partially forms a wall enclosing the gas cushion.

24. The offshore structure according to claim 22, wherein a space remaining between said compression chamber and said hollow structural element is filled with water.

25. The offshore structure according to claim 17, wherein said expansion vessel comprises a diaphragm separating the gas cushion from the insulating liquid.

26. The offshore structure according to claim 17, wherein said liquid-filled pipeline has a Buchholz relay.

27. The offshore structure according to claim 15, wherein said electrical device is a transformer.

28. The offshore structure according to claim 15, comprising a wind power installation.
